(19) United States
(12) Patent Application Publication
(10) Pub. No.: US 2004/0165476 A1
(43) Pub. Date: Aug. 26, 2004

(54) Two component coating mixing system

(76) Inventors: Jorge Arthur Millan, Lawndale, CA (US); Glen Silva Abad, Placentia, CA (US); Arnold Comproni, Sylmar, CA (US)

Correspondence Address: LOUIS L. DACHS, 1794 PALISADES DRIVE, PACIFIC PALISADES, CA, 90272, US

(21) Appl. No.: 10/373,604

(22) Filed: Feb. 24, 2003

(51) Int. Cl. G05D 11/02

(52) U.S. Cl. 366/152.2; 366/182.4

(57) ABSTRACT

The invention is a system for mixing first and second components of a coating to be applied to a surface in a precise ratio. The system includes a mixer within which the first and second components are combined to form a mixture. A first supply transmits the first component at a first flow rate to the mixer, the first supply producing a first flow rate signal representative of the first flow rate. A second supply which transmits the second component at a second flow rate to the mixer, the second supply producing a second flow rate signal representative of the second flow rate. First and second flow control valves are connected between the first and second supplies, respectively, and the mixer for controlling the first and second flow rates from the first and supplies in accordance with a timed duty cycle. A controller controls the operation of the first and second control valves in response to received first and second flow rate signals, such that the first and second flow control valves are never opened simultaneously.

### BACKGROUND OF THE INVENTION

1. Field of the Invention

The invention relates to the field of coating mixing systems for spray painting and, in particular, to a coating mixing system for accurately mixing a base part with a catalyst.

2. Description of Related Art

When spray painting using a two-part paint, a base resin and catalyst, great care must be exercised to insure that the proper ratio between the two is maintained. Examples of two component mixing systems are disclosed in U.S. Pat. No. 4,376,512 “Coating System” by K. Kisner and U.S. patent application Publication No. 2001/0030241 A1 “Method And Apparatus For Truck Bed Liners” by J. M. Knit, et al. In both inventions pumps are used to transfer the components to a mixer and then on to a spay gun. However, there is no capability to insure that the two components are automatically mixed in the proper ratio.

U.S. Pat. No. 6,203,183 “Multiple Component In-Line Paint Mixing System” by K. M. Mordaunt, et al. discloses a paint mixing system wherein pumps coupled to tanks of base material and catalyst direct the base material and catalyst through control valves and thereafter to a mixer. A flow meter down stream of the mixer measures the flow rate of the now mixed base material and catalyst. The problem with this approach is, that while the flow of the base material and catalyst are controllable by the valves, precise mixing can not be maintained because the actual flow rate the base material and catalyst is not known.

U.S. Pat. No. 5,490,726 “Apparatus For Proportioning Two Components To Form A Mixture” and U.S. Pat. No. 5,407,267 “Method And Apparatus For Forming And Dispensing Coating Material Containing Multiple Components” both by D. Davis, et al. are of interest in that more precise control of the addition of the catalyst is provided. Here flow meters are incorporated to monitor the flow rate of the base material and catalyst prior to mixing. The output signals from the two flow meters is used to determine the actual ratio of base material and catalyst, which are compared to the desired ratio. The error signal is used to control a solenoid valve in the catalyst feed line upstream of the mixer insuring that the proper ratio is maintained.

While the systems disclosed by D. Davis, et al. will greatly help insure that the proper ratio of base material to catalyst will be maintained, it has limited use in situations where the base material has a very high viscosity compared to the catalyst. For example, where the base material is loaded with metallic particles and thus has a very high viscosity. Such high viscosity materials significant resistance and must be pumped under high pressure. Thus when the solenoid valve in the catalyst line is opened base material, which is continuously flowing, can be forced into the catalyst line causing curing to start prior to the desired point in the system. In addition, even more control over the mixing of the two components is desirable.

Thus, it is a primary object of the invention to provide a two component mixing system for a paint spraying system.

It is another primary object of the invention to provide a two component mixing system for a paint spraying system that can be used when the base material has a viscosity considerably higher than the catalyst.

It is a further object of the invention to provide a two component mixing system for a paint spraying system that eliminates the possibility of base material mixing with the catalyst prior to a mixer.

### SUMMARY OF THE INVENTION

The invention is a system for mixing first and second components of a coating to be applied to a surface in a precise ratio. For example, a coating including a resin and catalyst for curing the resin. The system includes a mixer within which the first and second components are combined to form a mixture. A first supply system transmits the first component at a first flow rate to the mixer, the first supply producing a first flow rate signal representative of the first flow rate. The supply system includes a tank for holding the first component and a pump for pumping the first component therefrom. A first flow meter is coupled between the first pump and the mixer for measuring the flow rate of the first component and providing a first signal representative thereof.

A second supply system transmits the second component at a second flow rate to the mixer, the second supply producing a second flow rate signal representative of the second flow rate. The second supply system includes a tank for holding the second component and a second pump for pumping the second component therefrom. A second flow meter is coupled between the second pump and the mixer for measuring the flow rate of the second component and providing a second signal representative thereof.

First and second flow control valves are connected between the first and second supplies, respectively, and the mixer for controlling the first and second flow rates from the first and supplies in accordance with a timed duty cycle. A controller controls the operation of the first and second control valves in response to received first and second flow rate signals, such that the first and second flow control valves are never opened simultaneously. This controller includes electrical circuitry operative to process the first and second flow rate signals and to produce an output which controls the duty cycle of the first and second control valves.

In particular, if the first component is a high viscosity resin loaded with metallic particles, the first flow meter is preferably a Corriollis mass flow meter. The second component is typically a low viscosity catalyst and the second flow meter is preferably positive displacement gear flow meter. It is preferred that the first and second control valves be pneumatic solenoid valves.

The advantage of this system is that precise metering of the two components maintained. In addition, preventing both valves from being opened at the same time, mixing of the resin and catalyst can only occur in the mixer and not in the lines. Because the resin is a higher viscosity material it requires a greater pumping pressure and thus, if the both valves were open at the same time, there is a possibility of the resin contacting the catalyst in the catalyst line.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is a simplified schematic of the system.

FIG. 2 is a simplified flow chart of the operation of the machine.

### DESCRIPTION OF THE PREFERRED EMBODIMENT

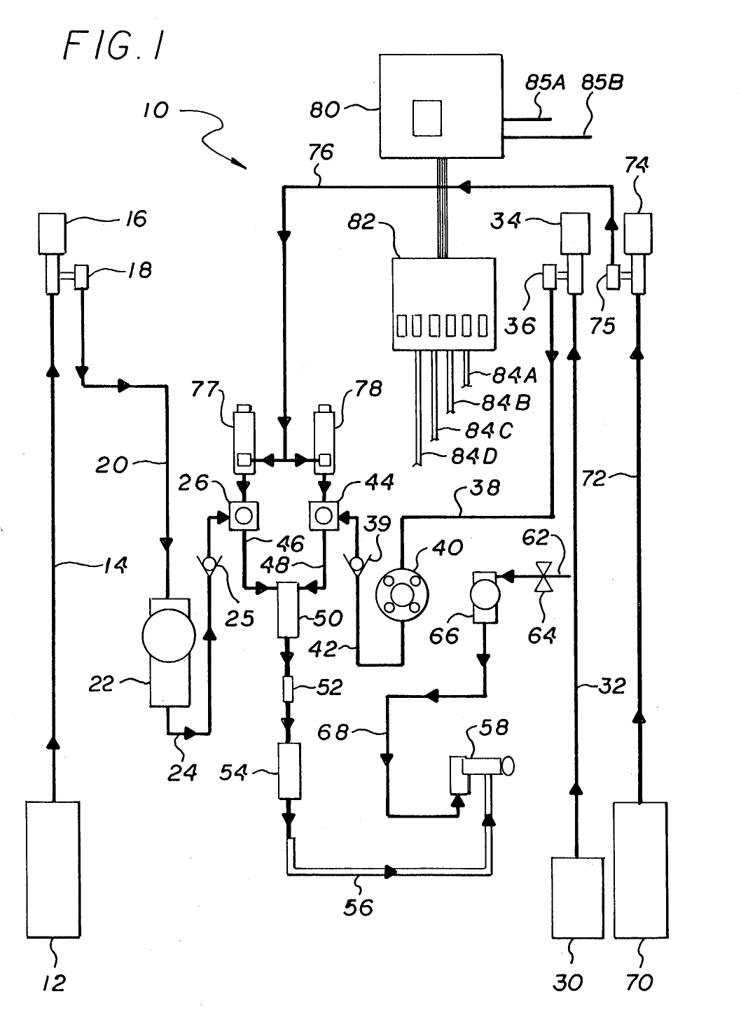

Referring to FIG. 1, the system generally designated by numeral 10, includes a tank 12 for the resin part of the two component coating system. The tank 12 is connected by line 14 to a pump 16 the output of which is coupled to a pressure regulator 18 used to regulate the pressure produced by the pump. A suitable pump 16 is a Binks Company hydraulic pump (Part no. 871110), Glendale Heights, Ill. A suitable pressure regulator is I.R. ARO Downstream Fluid Pressure Regular (Part no. 651790-B3E-B) manufactured by Ingersoll-Rand Company, Bryan, Ohio. The pressure regulator 18 is coupled to output line 20, which connects to a flow meter 22. Preferably, the flow meter 22 is a coriolis type flow meter. For example, an Endress+Hauser Coriolis Mass Flow meter, (Part no. PROline Promass 80/83 A) manufactured by Endress+Hauser Incorporated, Greenwood, Ind. Such a flow meter is necessary if the resin is very viscous; for example if the resin is “loaded with finely dispersed metal particles. An output line 24, having a check valve 25 mounted therein, extends from the flow meter 22 and connects to a solenoid valve 26. Preferably, the solenoid valve 26 is a pneumatically operated type.

The system 10 also includes a tank 30, containing the catalyst, and which is connected by line 32 to a pump 34. A pressure regulator 36 is connected to the output of the pump 34 and regulates the output pressure from the pump. A line 38, having a check valve 39 mounted therein, connects output from the regular 36 to a flow meter 40. Preferably, the flow meter 40 is a meshed gear type flow meter. For example a Graco Gear flow Meter manufactured by Graco, Incorporated, Minneapolis, Minn. Such a flow meter is ideal for low viscosity materials such as the catalyst. The output line 42 of the flow meter 40 connects to a solenoid valve 44. Preferably, the solenoid valve 44 is a pneumatically operated type similar to valve 26.

The two components, resin and catalyst from solenoid valves 26 and 44 enter lines 46 and 48 which deliver them to a pre-mix integrator 50 and thereafter to a static mixer tube 52 and finally to a dynamic mixer 54. From thereafter it enters a flexible static mixing line 56, which is connected to the air spray gun 58. A line 62 coupled to a pressurized air supply (not shown) containing a shut off valve 64 is coupled to an automizing air pressure regulator 66. A flexible airline 68 couples the regulator 66 to the spray gun 58.

It is obvious that after any spraying operation, mixed resin and catalyst remains in the pre-mix integrator 50, static mixer tube 52, dynamic mixer 54, line 56 and spray gun 58. After spray operations, it is necessary to purge all these components. This is accomplished by a purging system comprising a tank 70 containing solvent, which is coupled by line 72 to a pump 74. A pressure regulator 75 is coupled to the output of the pump 74 and regulates the output pressure therefrom. A line 76 is coupled to the output of the regulator 75 and connects to solvent purge solenoid valves 77 and 78 (preferably pneumatically actuated). The valves 77 and 78 in turn couple to solenoid valves 26 and 44, respectively. Thus with solenoid valves 26, 44, 77 and 78 open and pump 74 in operation, all components having mixed resin and catalyst can be purged when the spray gun 58 is opened. Check valves 25 and 39 prevent the flow of solvent into lines 24 and 42, respectively.

The valves 26, 44, 77 and 78 and pre-mix integrator 50 can be combined into a single unit. For example, Graco Incorporated, Minneapolis, Minn. produces such an assembly called a Plural Component Mix Manifold (Part No. 236931)

A controller 80 is used to control the cycling of the solenoid valves 26 and 44 and is connected to an air solenoid control box 82 which actuates the valves via pneumatic lines:

Line 84A—Valve 26

Line 84B—Valve 44

Line 84C—Valve 77

Line 84C—Valve 78

Electrical lines:

Line 85A—flow meter 22

Line 85B—Flow meter 40.

A suitable controller 80 is a Precision Mix Proportioning Controller (Part No. 965739) and the air solenoid control box (Part No. 570-126, both manufactured by Graco Incorporated.

The ratio of the resin to catalyst necessary for proper curing is always known. Thus it is a simple matter to adjust the duty cycle of each valve 26 and 44. For example suppose that 100 cubic centimeters (cc) of resin require 50 cubic centimeters to accomplish curing. The controller 80 would be programmed to keep valve 26 open until 100 cc of resin has flowed therethrough as measured by flow meter 22 and then shut it off. Valve 44 would then be opened until 50 cc of catalyst has flowed therethrough as measured by flow meter 40. The duty cycles of each valve is kept very short in order to insure good mixing. For example the duty cycle for valve 26 is usually kept at around 3 seconds, thus the duty cycle of valve 44 is around a second or less.

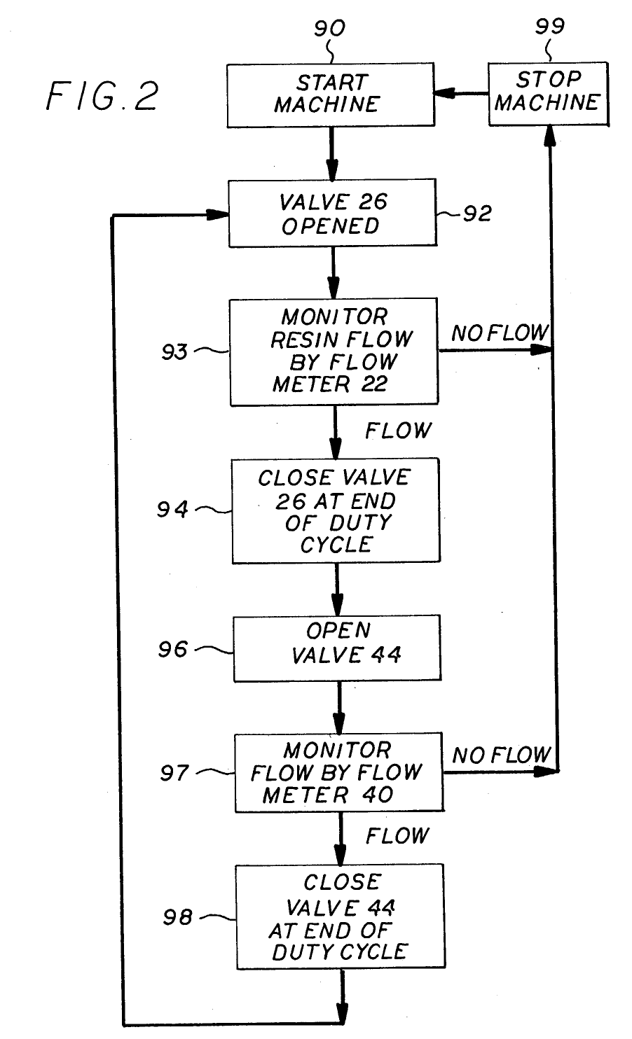

In operation, once the system has been turned on and valves 26 and 44 continue to cycle and until all the components down stream of the valves are filled (pre-mix integrator 50, static mixer tube 52, dynamic mixer 54, and flexible static mixing line 56). At that point no additional flow is possible. When no flow is sensed by the controller it stops the cycle. Referring to FIG. 2, the steps are as follows:

Step 90—Start switch in Controller 80 actuated.

Step 92—Valve 26 is opened starting resin flow.

Step 9—Monitor flow meter 22, if flow then Step 94, if no flow Step 99.

Step 94—Close valve 26 at end of duty cycle.

Step 96—Open valve 44 to start catalyst flow..

Step 97—Monitor catalyst flow by flow meter 44, if flow Step 98, if no flow Step 99

Step 98—Cose valve 44 at end of duty cycle and return to Step 92.

Step 99—Stop System.

If the machine is stopped mid-cycle, the process is stopped immediately, and will restart at the same point in the cycle, thus insuring the proper mixture ratio is always maintained. It should be understood that pump output pressures will very depending upon the coatings as well as the ratio of resin to catalyst. Another variable is the air pressure required for spray gun. All these variables can be obviously accommodated by the controller 80.

The main advantage of the system is that because a solenoid valve is used to control both the catalyst and resin flow continuous determination of the actual mixing ratios is unnecessary. This allows a much similar control system to be used. Secondly, there is no possibility of the resin and catalyst prior to intended point of mixing.

While the invention has been described with reference to a particular embodiment, it should be understood that the embodiment is merely illustrative, as there are numerous variations and modifications, which may be made by those skilled in the art. Thus, the invention is to be construed as being limited only by the spirit and scope of the appended claims.

### INDUSTRIAL APPLICABILITY

The invention has applicability to the paint and other coating industries.

1. A system for mixing first and second components in a precise ratio, the system comprising:
a mixer within the first and second components are combined to form a mixture;
a first supply which transmits the first component at a first flow rate to said mixer, said first supply producing a first flow rate signal representative of said first flow rate;
a second supply which transmits the second component at a second flow rate to said mixer, said second supply producing a second flow rate signal representative of said second flow rate;
first and second flow control valves connected between said first and second supplies, respectively, and said mixer for controlling the first and second flow rates from said first and second supplies in accordance with a timed duty cycle for each; and
a controller operative to control the operation of said first and second control valves in response to received first and second flow rate signals, such that said first and second flow control valves are never opened simultaneously during there respective duty cycles.

2. The system as set froth in claim 1 comprising:
said first supply comprising;
a first pump coupled to a source of the first component;
a first flow meter coupled to said first pump between said first pump and said mixer for measuring the flow rate of said first component and providing said first flow rate signal;
said supply comprising:
a second pump coupled to a source of the second component;
a second flow meter coupled to said second pump between said second pump and said mixer for measuring the flow rate of said second component providing said second flow rate signal.

3. The system as set forth in claim 2 in which the controller includes electrical circuitry operative to process said first and second flow rate signals and to produce an output which controls said duty cycle of said first and second control valves.

4. The system as set forth in claim 2, or 3 wherein said first flow meter is a Corriolis mass flow meter and said second flow meter is a positive displacement gear flow meter.

5. The system as set forth in claim 4 comprising said first and second control valves are pneumatic solenoid valves.

6. A system for mixing first and second components in a precise ratio, the system comprising:
a mixer within the first and second components are combined to form a mixture;
a first supply for transferring the first component of the mixture to said mixer, said first supply comprising:
a first pump coupled to a source of the first component; and
a first flow meter coupled to said first pump between said first pump and said mixer for measuring the flow rate of said first component and providing a first signal representative thereof;
a first control valve for controlling the flow of the first component to said mixer mounted between said first flow meter and said mixer;
a second supply for transferring the second component of the mixture to said mixer, said second supply comprising:
a second pump coupled to a source of the first component; and
a second flow meter coupled to said second pump between said second pump and said mixer for measuring the flow rate of said second component providing a second signal representative thereof;
a second control valve for controlling the flow of the second component to said mixer mounted between said second flow meter and said mixer; and
a controller operative to control the operation of said first and second control valves in response to received signals from said first and second flow meters.

7. The system as set forth in claim 6 wherein said first flow meter is a Corriolis mass flow meter and said second flow meter is a positive displacement gear flow meter.

8. The system as set forth in claim 7 comprising said first and second control valves are pneumatic solenoid valves;
